(19) United States
(12) Patent Application Publication
(10) Pub. No.: US 2012/0170319 A1
(43) Pub. Date: Jul. 5, 2012

(54) Apparatus and method for converting a low AC voltage to a high DC voltage

(76) Inventor: Michael Singaliese, New Canaan, CT (US)

(21) Appl. No.: 13/374,493

(22) Filed: Dec. 30, 2011

Related U.S. Application Data
(60) Provisional application No. 61/460,388, filed on Dec. 31, 2010.

(51) Int. Cl. H02M 7/02

(52) U.S. Cl. 363/13

(57) ABSTRACT

An apparatus, including an AC voltage transforming device increases an AC voltage input signal to a higher AC voltage signal, an AC to DC voltage conversion device which converts the higher AC voltage signal to a DC voltage, wherein the DC voltage has a higher voltage level than the peak or peak-to-peak voltage level of the higher AC voltage signal, a DC to DC conversion device which converts the DC voltage input to a higher DC voltage output, and a DC voltage to load connecting device which connects the higher DC voltage to an electrical load when the output of the DC to DC voltage conversion device attains a desired amplitude or an amplitude needed to drive the electrical load.

### RELATED APPLICATIONS

This application claims the benefit of the priority of U.S. Provisional Patent Application Ser. No. 61/460,388 filed Dec. 31, 2010, and entitled “APPARATUS AND METHOD FOR CONVERTING A LOW AC VOLTAGE TO A HIGH DC VOLTAGE”, the subject matter and teachings of which are hereby incorporated by reference herein in their entirety.

### FIELD OF THE INVENTION

The present invention provides an apparatus and a method for converting a low AC (Alternating Current) voltage to a high DC (Direct Current) voltage.

### SUMMARY OF THE INVENTION

The present invention provides an apparatus and a method for converting a low AC (Alternating Current) voltage to a high DC (Direct Current) voltage.

The present invention can include an AC voltage input device which can be any AC voltage source, an AC voltage transforming device, which can be any suitable transformer, transformers, or any other suitable AC voltage transforming device, which can be used to initially increase an AC voltage input to a higher AC voltage, an AC to DC voltage conversion device which can be any suitable device which converts the higher AC voltage to a DC voltage which is greater than the peak or peak-to-peak value of the higher AC voltage, a DC to DC conversion device which can be any suitable device which converts the DC voltage to a higher DC voltage, and a DC voltage to load connecting device which can be any suitable device which is used to connect the higher DC voltage output to an electrical load when the higher DC voltage has attained a desired amplitude, and an electrical load 6 which can be any suitable electrical load.

The AC voltage input device can be connected to the input of the AC voltage transforming device, the output of the AC voltage transforming device can be connected to the input of the AC to DC voltage conversion device, the output of the AC to DC conversion device can be connected to the input of the DC to DC voltage conversion device, the output of the DC to DC voltage conversion device can be connected to the input of the DC voltage to load connecting device, and the output of the DC voltage to load connecting device can be connected to the electrical load.

The present invention can be utilized and/or can be operated in the following manner so as to convert a low AC voltage to a higher DC voltage. The AC voltage input device can supply or provide an AC voltage input signal, which is the signal to be converted to a higher DC voltage, to the input of the AC voltage transforming device which can increase or “step up” the AC voltage input signal to a higher AC voltage signal or an AC voltage having a higher voltage level than the AC voltage input signal.

The AC voltage transforming device can provide its output, which is the higher AC voltage signal to the input of the AC to DC voltage conversion device which can convert the higher AC voltage signal to a DC voltage which has a higher voltage level than the peak or peak-to-peak voltage level of the higher AC voltage signal. The output of the AC to DC voltage conversion device can be fed into the DC to DC conversion device which converts or “steps-up” the DC voltage input to a higher DC voltage output. The higher DC voltage output of the DC to DC voltage conversion device can be fed into the input of the DC voltage to load connecting device which can connect the higher DC voltage, which is the output of the DC to DC voltage conversion device, to the electrical load when the output of the DC to DC voltage conversion device attains a desired amplitude or an amplitude needed to drive the electrical load. In the above-described manner, the present invention can be utilized in order to convert a low AC voltage input to a high DC voltage output.

### BRIEF DESCRIPTION OF THE DRAWINGS

FIG. 1 illustrates a block diagram of a preferred embodiment of the voltage conversion apparatus of the present invention.

### DESCRIPTION OF THE PREFERRED EMBODIMENT

The present invention provides an apparatus and a method for converting a low AC (Alternating Current) voltage to a high DC (Direct Current) voltage.

In a preferred embodiment, the apparatus of the present invention, which is designated generally by the reference numeral 100, includes an AC voltage input device 1 which can be any AC voltage source, an AC voltage transforming device 2, which can be any suitable transformer, transformers, or any other suitable AC voltage transforming device, which can be used to initially increase an AC voltage input to a higher AC voltage, an AC to DC voltage conversion device 3 which can be any suitable device which converts the higher AC voltage to a DC voltage which is greater than the peak or peak-to-peak value of the higher AC voltage, a DC to DC conversion device 4 which can be any suitable device which converts the DC voltage to a higher DC voltage, and a DC voltage to load connecting device 5 which can be any suitable device which is used to connect the higher DC voltage output to an electrical load when the higher DC voltage has attained a desired amplitude, and an electrical load 6 which can be any suitable electrical load.

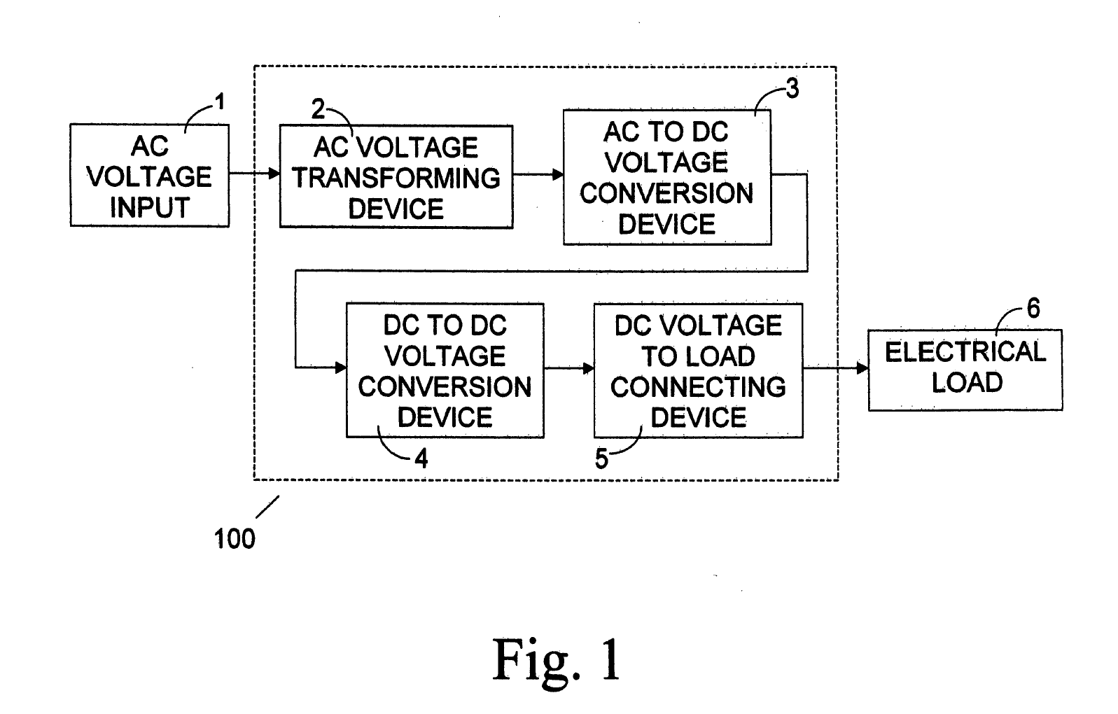

In the preferred embodiment of FIG. 1, the AC voltage input device 1 is connected to the input of the AC voltage transforming device 2 as shown, the output of the AC voltage transforming device 2 is connected to the input of the AC to DC voltage conversion device 3 as shown, the output of the AC to DC conversion device 3 is connected to the input of the DC to DC voltage conversion device 4 as shown, the output of the DC to DC voltage conversion device 4 is connected to the input of the DC voltage to load connecting device 5 as shown, and the output of the DC voltage to load connecting device 5 is connected to the electrical load 6 as shown.

The apparatus 100 of the present invention can be utilized and/or can be operated in the following manner so as to convert a low AC voltage to a higher DC voltage. The AC voltage input device 1 supplies or provides an AC voltage input signal, which is the signal to be converted to a higher DC voltage, to the input of the AC voltage transforming device 2 which increases or “steps up” the AC voltage input signal to a higher AC voltage signal or an AC voltage having a higher voltage level than the AC voltage input signal.

The AC voltage transforming device 2 provide its output, which is the higher AC voltage signal to the input of the AC to DC voltage conversion device 3 which converts the higher AC voltage signal to a DC voltage which has a higher voltage level than the peak or peak-to-peak voltage level of the higher AC voltage signal. The output of the AC to DC voltage conversion device 3 is fed into the DC to DC conversion device 4 which converts or “step-up” the DC voltage input to a higher DC voltage output. The higher DC voltage output of the DC to DC voltage conversion device 4 is fed into the input of the DC voltage to load connecting device 5 which connects the higher DC voltage, which is the output of the DC to DC voltage conversion device 4, to the electrical load 6 when the output of the DC to DC voltage conversion device attains a desired amplitude or an amplitude needed to drive the electrical load 6. In the above-described manner, the apparatus 100 of the present invention can be utilized in order to convert a low AC voltage input to DC voltage output.

What is claimed is:

1. An apparatus, comprising:
an AC voltage transforming device increases an AC voltage input signal to a higher AC voltage signal;
an AC to DC voltage conversion device which converts the higher AC voltage signal to a DC voltage, wherein the DC voltage has a higher voltage level than the peak or peak-to-peak voltage level of the higher AC voltage signal;
a DC to DC conversion device which converts the DC voltage input to a higher DC voltage output; and
a DC voltage to load connecting device which connects the higher DC voltage to an electrical load when the output of the DC to DC voltage conversion device attains a desired amplitude or an amplitude needed to drive the electrical load.
